(19) United States
(12) Patent Application Publication
(10) Pub. No.: US 2021/0174293 A1
(43) Pub. Date: Jun. 10, 2021

(54) METHOD AND SYSTEM FOR SHIPPING AND RECEIVING PROCESS AUTOMATION

(71) Applicant: Holo Sail Technologies, Omaha, NE (US)

(72) Inventors: John Paul Vaughn Walker, II, West Caldwell, NJ (US); Horence Daus Hernando, West Caldwell, NJ (US); Luke Pearse Glaser, West Caldwell, NJ (US); Joseph O'Callaghan Glaser, JR., West Caldwell, NJ (US)

(73) Assignee: Holo Sail Technologies, Omaha, NE (US)

(21) Appl. No.: 17/074,484

(22) Filed: Oct. 19, 2020

Related U.S. Application Data
(60) Provisional application No. 62/916,930, filed on Oct. 18, 2019.

(51) Int. Cl. G06Q 10/08; H04L 9/06

(52) U.S. Cl. CPC G06Q 10/0833; H04L 2209/38; H04L 9/0643

(57) ABSTRACT

Provided is a system for securely and safely shipping goods and services from supply source to a final destination using a computer-based Holochain platform. The system includes container means, designate means attached to said container, for generating data for real-time geo-tracking and status monitoring of conditions both inside and outside of the container, and communication means for transmitting data streams to and from the Designate means and other components of the Holochain platform. Also included are computer means using Holochain logic means for processing data uploaded from the Designates and data stream monitor means by which customers and clients can access their personal manifests via HoloSail Designates during transit and receive appropriate payment upon delivery.

### I. FIELD OF THE INVENTION

The present invention relates generally to developing a process for using a specialized network as a foundation for software to automate shipping and receiving from a supply source to a final destination.

### II. BACKGROUND OF THE INVENTION

### Problem

One of the oldest industries on Earth needs a massive update and overhaul. Typical problems that plague the sector include: needless expensive paper trails, that are not only ineffective but increase the aspect of human error, security of information, lost items such as funds, cargo, and decreased production. Our invention can increase efficiency in movement of containers to and from destination, replace outdated tracking systems that include the tracking of shipments, money, and vessels. Our invention can be used for creating efficiency and security in the transport of goods without creating more infrastructure that cannot be accommodated by due to lack of land.

### Prior Art

The competitors are searching in the wrong direction, for example, Maersk and IBM's Tradelens which is based on a blockchain platform. Blockchain has been the goal of competitors for years now. How to harness the power of the blockchain to achieve their goals of speed, security, and digitalization.

To briefly define blockchain: A blockchain is a digital record of transactions. The name comes from its structure, in which individual records, called blocks, are linked together in a single list, called a chain or ledger. To make a change to the ledger, it first must be validated along the entire chain regardless of what the content involves. This is considered a data-centric approach.

### III. SUMMARY OF EMBODIMENTS OF THE INVENTION

Given the aforementioned deficiencies, a need exists for a better solution. What competitors have been missing is what our software will use as a foundation network known as Holochain.

What we are using as Holochain is defined as a scalable, “agent-centric” distributed computing network. Unlike other decentralized platforms, the “consensus” engine utilizes a validating distributed hash table (DHT), requiring only nodes that are exchanging data with one another to reach a state of agreement. This makes transaction speeds and amounts near-limitless, making it ideal for our transactions. In fact, after a conversation with the Network development team, more transactions we add to the network, the faster it will work, and with our projections, we will be registering millions of transactions of data in a very short amount of time.

With this, we have already solved multiple issues that the competition is still trying to figure out with blockchain. We enable limitless volume of data to be moved in a blink of an eye, security on the foundation level that will be near impossible to crack due to the validation methods used with security for the companies that will keep out unauthorized personnel, and finally the ability to bring the United States to the for front of shipping technology bringing together the United States and other world leaders in the shipping industries.

Benefits

Benefits of the inventive Holochain solution we are bringing to the table include: the ability to track and monitor transactions every step of the way with auto validation once an active task is complete, this includes tracking the position of the containers at all times, which is vital for reducing cargo loss and human error. We are also offering something that is unheard of in the industry; The ability for potentially unlimited scalability on the network this is a problem that has plagued blockchain since its inception and with the Holochain Network we intend to revolutionize the industry with no bottlenecking of transactions, privacy, and security that is second to none, along with seamless ability to make payments from one local currency to another at speeds never seen before by the industry

Embodiments of the present invention, under certain circumstances, provide a system for securely and safely shipping goods and services from supply source to a final destination using a computer-based Holochain platform. The system includes container means, designate means attached to said container, for generating data for real-time geo-tracking and status monitoring of conditions both inside and outside of the container, and communication means for transmitting data streams to and from the Designate means and other components of the Holochain platform. Also included are computer means using Holochain logic means for processing data uploaded from the Designates and data stream monitor means by which customers and clients can access their personal manifests via HoloSail Designates during transit and receive appropriate payment upon delivery.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### IV. BRIEF DESCRIPTION OF THE DRAWINGS

The accompanying drawings, which are incorporated herein and form part of the specification, illustrate the present invention and, together with the description, further serve to explain the principles of the invention and to enable a person skilled in the relevant art(s) to make and use the invention.

FIG. 1 is an illustration of an exemplary HoloSail technologies shipping process overview in accordance with embodiments of the present invention; and

FIG. 2 is a block diagram of an exemplary data update and verification process using a specialized Holochain Network in accordance with the embodiments.

FIG. 3 illustrates a computing device in accordance with the embodiments.

### V. DETAILED DESCRIPTION OF EMBODIMENTS OF THE INVENTION

While the present invention is described herein with illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

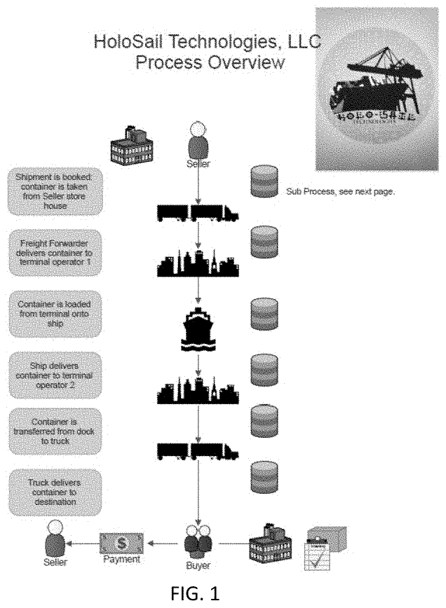

As illustrated in FIG. 1, embodiments of the present invention include a process for using a specialized (e.g., Holochain) network as a foundation for software to automate shipping and receiving. The automation extends from a supply source to a final destination and from wholesale to individual deliveries of goods or services. The definition of a blockchain is: a list of digital records of transaction data linked cryptographically. As understood in the art, the name comes from the structure, in which individual records, called blocks, are linked together in a single list, called a chain or ledger.

To make a change to the ledger, it must first be validated along the entire chain regardless of what the content involves. This is considered a data-centric approach. The definition of Holochain is a scalable, “agent-centric” distributed computing platform, considered to be a derivative of blockchain. Unlike other decentralized platforms, the “consensus” engine utilizes a validating DHT, requiring only nodes, also called agents, that are exchanging data with one another to reach a state of agreement. A further explanation of Holochain specifications, as it is an open-source, freely distributed platfrom, may be found in the whitepaper here: https://github.com/holochain/holochain-proto/blob/whitepaper/holochain.pdf.

The Holochain platform makes transaction speeds and volumes near-limitless, making it ideal for transactions of a large scale, on the order of billions of transaction per year. Holochain limits the data sharing to only the parties involved in the transaction instead of all members of the ledger. This process can simplify and improve the accuracy of shipping goods and services, along with allowing for rapid payment.

The software will identify the parties involved in a shipping and delivery transaction, track the delivery throughout the actual transport of the goods or services, and execute a transfer of funds upon the delivery of the products or services to the final destination or customer.

The value of tracking on the Holochain network is similar to blockchain technology in terms of security and confidence, however only the parties to the transaction receive the information instead of all members of the blockchain. This reduces massive amounts of unrelated data occupying storage facilities and improves the privacy of transactions between parties. One of the first areas we are focusing on is the container shipping industry including: stevedoring, maritime, intermodal, and trucking of containers from source to the final destination.

In a typical transaction, a producer of a particular product will need to ship goods (usually in bulk) from their factory or warehouse to a wholesaler or retailer in another location. When shipping to another country, it is generally more cost-effective to ship via ocean and truck using standard containers that take advantage of transfer facility technologies.

The process involves hiring a freight forwarding agent to find a local truck carrier to come to the factory to bring and/or pick up the full container and deliver it to the loading dock of a shipping terminal operator at a time and location determined by the shipping line that the freight forwarder arranges to book the shipment with. The terminal operator unloads the container from the truck, usually via a crane, and loads it onto the ship.

The ship then sails the oceans and seas to the most efficient port near the final customer and docks at that local terminal operator's facility. The terminal operator at the destination port unloads the container from the ship to the dock; then loads the container from the dock to a truck. The truck then takes the container to the final destination. Under most current systems, the paperwork and paper trail to track these systems takes, in some cases, months for the final payment to reach the supplier.

The value-added feature to the process is the use of the Holochain platform to track the transaction throughout the process and in the case of FOB Destination, immediate payment in the local currency upon delivery to the destination, rather than waiting for the paper trail to catch up.

### Steps in the Process

Holochain Technology starts the process with the freight forwarder as soon as the shipment is booked. The parties involved will be able to track each step of the process. With only those parties having access to the booking in real-time. The time and date of the truck pick up is detected and passed on to all parties. The transfer from truck to the terminal operator is detected then transmitted to the computers of all the involved parties.

The loading of the container onto the ship by the terminal operator is detected, and that data is available to all parties to the transaction. The transfer of the container to the dock by the terminal operator at the destination port is detected and passed on to all parties. The transfer of the container from the dock to the destination truck is detected and passed on to all the parties. The delivery of the container to the final destination is detected and passed on to all the parties, and payment of the goods is made immediately in the seller's local currency vie atomic swap utilizing the Holochain networks cryptocurrency Holofuel upon acceptance by that customer.

When exemplary business model includes charging each of the participants a nominal fee for tracking the progress of the shipment and providing detailed data every step of the way that can be utilized by the shipping lines and ports to analyze data to show their shareholders improvements to overall efficiency, loss rates, and intermodal throughput.

Using state of the art technology, along with Holochain Networking, transportation and shipping services are being developed that have been clinging to outdated methods. These transportation and shipping services transformed into modern, digital efficiencies in to dominate the constantly growing marketplace. These technologies (e.g., Designate) will be attached to the container, monitoring conditions inside and out, feeding that data in real time into the Designate.

The data is then uploaded to the Network, creating a data stream that customers and clients can access to monitor their personal manifests via HoloSail Designates stand-alone portal. The Designate is by no means just an advanced gauge. It also sends signals to show where on the ship it is and its current conditions, recording and alarming crew if there is a shift in position that could cause an accident or personnel injury, reducing the likelihood of cargo falling overboard.

Another feature of Designate is its ability to know where it is going. With the digital manifests, with information on where it is supposed to be going it will alert dock side workers if it is moved in error. Also alerting the ship's crew to this error, reducing, with the goal of entirely eliminating the possibility of losses due to misplaced or lost cargo.

Being able to have real-time geo-tracking will also mitigate any growing pains during the transition into the full use of the state-of-the-art technology and automated processes. Designate, while made to interact with our other products, is also able to be utilized as a stand-alone system and transmit information to the appropriate portals.

Provided information includes:
Type of container ISO
Shipping line owner
Weight/dimensions
Inside conditions of the container such as temperature (low, high, current, reasonable range)
Humidity (acceptable range)
Current power drains and fluctuations in power connected to the container
Individual personalized shipping manifests
   accessible by all authorized personnel
Opening of container during transport
Off-loading within a given reasonable range at an incorrect destination will trigger crew alerts to reduce the number or misplaced containers
ETA on arrival date and time based on current speed and route specified
Crew alerts if container shifts profoundly during transport (this should assist in avoiding accidents and injury due to rough seas)
   This should also give the crew a chance to correct the shift and, if possible, to prevent any personnel risk or cargo loss

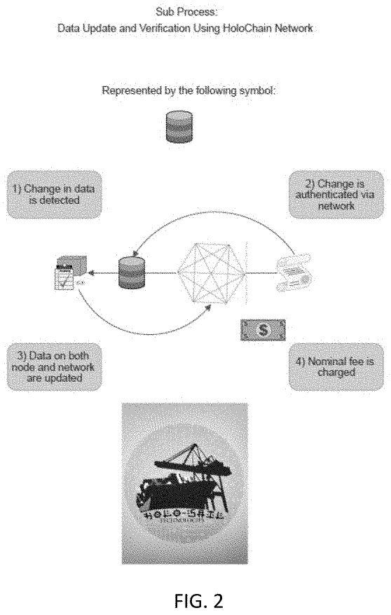

All of this information will be provided in an unbroken, real-time data stream to the agent. This will be accessible at any time from the client portal to know real-time information on their shipment. An exemplary process is illustrated in FIG. 2.

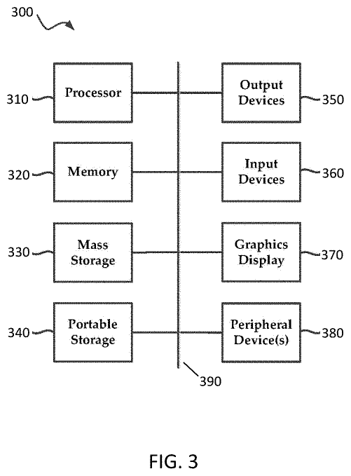

FIG. 3 is an illustration of an exemplary computing device 300 that may be used to implement an embodiment of the Holochain systems and methods disclosed herein. The system 300 of FIG. 3 may be implemented in the contexts of the likes of computing devices including PCs, laptops, smart phones, tablets, or alike, networks, servers, or combinations thereof.

The computing device 300 of FIG. 3 includes one or more processors 310 and main memory 320. Main memory 320 stores, in part, instructions and data for execution by processor 310. Main memory 320 may store the executable code when in operation. The system 300 of FIG. 3 further includes a mass storage device 330, portable storage device 340, output devices 350, user input devices 360, a display system 370, and peripheral devices 380.

The components shown in FIG. 3 are depicted as being connected via a single bus 390. The components may be connected through one or more data transport means. Processor unit 310 and main memory 320 may be connected via a local microprocessor bus, and the mass storage device 330, peripheral device(s) 380, portable storage device 340, and display system 370 may be connected via one or more input/output (I/O) buses.

Mass storage device 330, which may be implemented with a magnetic disk drive or an optical disk drive, is a non-volatile storage device for storing data and instructions for use by processor unit 310. Mass storage device 330 may store the system software for implementing embodiments of the present technology for purposes of loading that software into main memory 320.

Portable storage device 340 operates in conjunction with a portable non-volatile storage medium, such as a floppy disk, compact disk, digital video disc, or USB storage device, to input and output data and code to and from the computer system 300 of FIG. 3. The system software for implementing embodiments of the present technology may be stored on such a portable medium and input to the computer system 300 via the portable storage device 340.

User input devices 360 provide a portion of a user interface. User input devices 360 may include an alphanumeric keypad, such as a keyboard, for inputting alpha-numeric and other information, or a pointing device, such as a mouse, a trackball, stylus, or cursor direction keys. Additional user input devices 360 may comprise, but are not limited to, devices such as speech recognition systems, facial recognition systems, motion-based input systems, gesture-based systems, and so forth. For example, user input devices 360 may include a touchscreen. Additionally, the system 300 as shown in FIG. 3 includes output devices 350. Suitable output devices include speakers, printers, network interfaces, and monitors.

Display system 370 may include a liquid crystal display (LCD) or other suitable display device. Display system 370 receives textual and graphical information and processes the information for output to the display device.

Peripherals device(s) 380 may include any type of computer support device to add additional functionality to the computer system. Peripheral device(s) 380 may include a modem or a router.

The components provided in the computer system 300 of FIG. 3 are those typically found in computer systems that may be suitable for use with embodiments of the present technology and are intended to represent a broad category of such computer components that are well known in the art. Thus, the computer system 300 of FIG. 3 may be a personal computer, hand-held computing device, telephone, mobile computing device, workstation, server, minicomputer, mainframe computer, or any other computing device.

The computer may also include different bus configurations, networked platforms, multi-processor platforms, etc. Various operating systems may be used including Unix, Linux, Windows, Mac OS, Palm OS, Android, iOS (known as iPhone OS before June 2010), QNX, and other suitable operating systems.

It is noteworthy that any hardware platform suitable for performing the processing described herein is suitable for use with the systems and methods provided herein. Computer-readable storage media refer to any medium or media that participate in providing instructions to a central processing unit (CPU), a graphical processing unit (GPU), a processor, a microcontroller, or the like. Such media may take forms including, but not limited to, non-volatile and volatile media such as optical or magnetic disks and dynamic memory, respectively.

Common forms of computer-readable storage media include a floppy disk, a flexible disk, a hard disk, magnetic tape, any other magnetic storage medium, a CD-ROM disk, digital video disk (DVD), any other optical storage medium, RAM, PROM, EPROM, a FLASHEPROM, any other memory chip or cartridge.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

For example, various aspects of the present invention can be implemented by software, firmware, hardware (or hardware represented by software such, as for example, Verilog or hardware description language instructions), or a combination thereof. After reading this description, it will become apparent to a person skilled in the relevant art how to implement the invention using other computer systems and/or computer architectures.

It should be noted that the simulation, synthesis and/or manufacture of the various embodiments of this invention can be accomplished, in part, through the use of computer readable code, including general programming languages (such as C or C++), hardware description languages (HDL) including Verilog HDL, VHDL, Altera HDL (AHDL) and so on, or other available programming and/or schematic capture tools (such as circuit capture tools).

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

What is claimed is:

1. A system for securely and safely shipping goods and services from supply source to a final destination using a computer-based Holochain platform, comprising:
container means;
Designate means attached to said container, for generating data for real-time geo-tracking and status monitoring of conditions both inside and outside of the container;
communication means for transmitting data streams to and from the Designate means and other components of the Holochain platform;
computer means using Holochain logic means for processing data uploaded from the Designates; and
data stream monitor means by which customers and clients can access their personal manifests via HoloSail Designates during transit and receive appropriate payment upon delivery.
